(19) United States
(12) Patent Application Publication
(10) Pub. No.: US 2002/0082964 A1
(43) Pub. Date: Jun. 27, 2002

(54) Business system for surely trading used houses at low cost without paying brokerage fee

(76) Inventor: Yoichi Kihara, Yokohama-City (JP)

Correspondence Address: Yoichi Kihara, 36-5, KAWAWADAI, TSUZUKI-KU, YOKOHAMA-CITY, KANAGAWA-PREF., 224-0056, JP

(21) Appl. No.: 09/750,508

(22) Filed: Dec. 27, 2000

(51) Int. Cl. G06F 17/60

(52) U.S. Cl. 705/36

(57) ABSTRACT

A business system for providing a means for the direct negotiation for the trade of the used houses between the potential sellers and the potential buyers, wherein the agent (hereinafter referred to as the agent), designated based on the agreement between the seller and the buyer undertakes the various procedures such as the documentary procedure, legal procedure, contractual procedure such as the preparation of the contractual documents, the procedure for insurance, introduction of housing loan, security, maintenance and the like, and the agent charges its agent fee only for the services requested by the seller and the buyer, thereby reducing the financial burden of the seller and the buyer to a greatest possible extent.

### BACKGROUND OF THE INVENTION

The present invention relates to a business system for enabling both the sellers and the buyers of used houses to surely and safely make the trading of used houses without paying the brokerage fees to the realty agents.

It has been a conventional practice that, for the trading of the used houses, the potential sellers and the potential buyers entrust the searching of the used houses available for sale to the realty agents on condition that the agent fee will be paid to the realty agent when the trade of the used house is realized.

The conventional trading system for the used houses has the following problems:

a. The agent fee is too expensive to both the seller and the buyer.

b. Time made available by the real agent for physical inspection of the used houses by the potential buyer is not sufficient in general.

c. The chances provided by the real agent for physical inspection of the used house by the potential buyer are limited.

d. The absence of the chances of the direct contact between the potential seller and the potential buyer tends to entail misunderstanding and resulting trouble due to the lack of sufficient information.

Thus, the present invention is intended to resolve the above-mentioned problems so that the trading of the used houses can be made surely, safely and at lower expenses.

### SUMMARY OF THE INVENTION

The trading of the used houses is made through the direct negotiation between the potential seller and the potential buyer without using the service of the realty agent. The business system according to the present invention is designed so that, in order to assure for the object of the trade to be safely and surely delivered to the buyer from the seller and the payment for the delivered object to be made smoothly, the agent, designated based on the agreement between both the seller and the buyer, provides its comprehensive service covering the documentary procedure, legal procedure, preparation of written agreement, procedure for insurance, introduction of fund for purchasing, safety maintenance work and maintenance work of the purchased object and so that both the seller and the buyer pay the fee only for the services which they asked from the agent, thereby reducing the financial burden of the seller and the buyer to a greatest possible extent. According to this business system, the potential sellers and the potential buyers of the used houses are free to contact directly with one another for negotiation, and the agent will not intervene in the negotiation before the seller and the buyer reach an agreement on the trade. As a meeting place for the sellers and the buyers, the agent may provide a home page of free access dedicated to the trading of the used houses on a web site on the internet. The seller of the used house puts up on the home page the information about the used house such as the picture, desired selling price, dimensions, delivery date, location and the like. On the other hand, the potential buyer of the used house also puts up the information and conditions about the used house that it desires to purchase such as the desired purchasing price, location, dimensions and the like on the home page of the agent. The potential buyer contacts directly the seller for negotiation. When the potential seller and the potential buyer reaches an agreement on the trade of the used house, either the seller or the buyer or the both entrust to the agent the procedures which become necessary after the trade such as the procedure for maintenance and administration of the sold or acquired used house. If both the seller and the buyer has not used the service of the agent, the both need not pay any agent fee. Therefore, this business system according to the present invention is characterized by that the agent charges the agent fee to its client only when its service is requested and only as to the specific service requested by its client. Thus, this business system is designed for surely trading the used houses at low expenses without using the service of the realty agent that accompanies the payment of the realty brokerage commission.

### DETAILED DESCRIPTION OF THE INVENTION

The modes for carrying out the present invention will be explained in the following.

a. The agent provides a home page as a meeting place of the potential sellers and the potential buyers of the used houses at a web site on the internet. The potential sellers and the potential buyers allowed to access this home page without charge for putting up their individual pieces of information concerning the used houses.

b. The agent puts up on the home page the contents of its service and the fees thereof in detail. For example, the information to be put up on the home page includes the information about various expenses incidental to the agreement on the trade of the used house concluded between the seller and the buyer such as the kinds and expenses of insurance, maintenance cost of the used house, introduction of housing loans, repair expenses and the like.

c. The contents of the information that the potential seller puts up on the home page comprises the information about the age of the used house, layout, location, selling price, area of the lot, date of delivery, convenience of traffic, total available area of the house, general view of the house.

d. The contents of the information that the potential buyer puts up on the home page is almost similar to that by the potential seller, e.g., the budged available for purchasing, desired location, delivery data and so forth.

e. The seller and the buyer, who have reached an agreement on the trade of the used house after the negotiation, entrust the later cumbersome procedures including the maintenance and administration procedures to the agent, who act on behalf of the seller and the buyer according to the agreement concluded with both the seller and the buyer.

f. The agent provides services such as the preparation of written agreement, execution of legal procedure, preparation of various written documents, application for insurance, introduction of housing loan and the like, which are to be carried out on behalf of the seller and the buyer.

g. The agent puts up the contents its service on its home page so that both the potential sellers and the potential buyers can access thereto for requesting the service of the agent. The agent establish its own system for meeting the requests from the buyers after the conclusion of the trade agreement.

The direct negotiation between the potential seller and the potential buyer of the used house saves an expensive brokerage fee to be paid to the realty agent. Further, the post-trade procedures can be entrusted to the agent on the basis that the seller and the buyer pay the agent fee only for the used services, e.g., the services such as those relating to the transaction and intermediate, thereby limiting the expenditures only to the indispensable expenditures. Further, the procedures incidental to the transaction between the seller and the buyer being undertaken and the related services being provided by the agent upon request by the seller and the buyer, the delivery of the object, the payment therefor and others can be carried out smoothly. In the case of this business system, since the agent is able to provide its service without requiring the time-consuming and expensive service of the realty agent, the agent is able to provide its service to the potential sellers and the potential buyers of the used houses, and thus the increase in the demand for the service of the agent can be expected.

What is claimed is:

1] A business system for surely trading used houses at low cost without paying brokerage fee to realty agent, wherein a seller and a buyer of a used house meet directly for negotiation without asking the service of any realty agent; upon reaching an agreement on transaction, the parties to the agreement designate, upon mutual agreement, an agent (hereinafter referred to as the agent) who undertakes for the parties documentary procedure, legal procedure and security maintenance procedure comprehensively covering the services such as the preparation of trade contract documents, insurance documents, introduction of financial service, maintenance service of the house and the like, all these services being intended for reducing the financial burden on both the seller and the buyer; both the seller and the buyer are free to contact with each other in any form, and the agent, in principle, shall not intervene in the transaction for the used house before the seller and the buyer reach an agreement on the transaction; the agent provides a home page of free access exclusively for the information concerning the used houses as a meeting place of the sellers and the buyers at a web site of the internet; each of the potential sellers of the used houses put up on the home page the information about the house such as the appearance by picture, desired selling price, dimensions, date of delivery, location and the like, while the each of the potential buyers of the used house put up on the home page the information and conditions about desired buying price, location, dimensions and the like; each buyer contacts directly with each potential seller for negotiation; when the seller and the buyer have reached an agreement on the selling conditions and buying conditions, either the seller or the buyer or the both entrust the procedures relating to the trading contract, maintenance and security maintenance to the agent, provided that when both the seller and the buyer do not need to entrust such procedures to the agent, the both are not obligated to pay any agent fee to the agent; the agent is entitled to charge its agent fee to the seller and the buyer only when said procedures are entrusted to the agent.
